(19) United States
(12) Patent Application Publication
(10) Pub. No.: US 2005/0044852 A1
(43) Pub. Date: Mar. 3, 2005

(54) Brake master cylinder and manufacturing method therefor

(76) Inventors: Kaoru Tsubouchi, Toyota-city (JP); Katsuhiro Mita, Gamagouri-city (JP)

Correspondence Address: BURNS DOANE SWECKER & MATHIS L L P, POST OFFICE BOX 1404, ALEXANDRIA, VA, 22313-1404, US

(21) Appl. No.: 10/925,933

(22) Filed: Aug. 26, 2004

(30) Foreign Application Priority Data
Sep. 3, 2003 (JP) 2003-310977

(51) Int. Cl. B60T 11/20

(52) U.S. Cl. 60/562

(57) ABSTRACT

In a brake master cylinder, when a first piston is pushed forward, first and second fluid chambers of a cylinder which are partitioned respectively by first and second cup seals supply brake fluids therefrom to first and second brake systems. Even when slightly inclined upon receiving a pushing force, the first piston is slidably guided along a first sleeve which is softer than the first piston, without coming into contact with the cylinder body. Since the first piston is not abrasively damaged, it does not occur that the first cup seal is injured at a slide guide portion thereof. Further, each of the first sleeve and a second sleeve is separated at one portion in the circumferential direction throughout the whole length thereof, so that by being inserted from an opening end of the cylinder, the sleeves can be fit respectively in sleeve recesses which are annually formed respectively at a first piston guide portion of a cylinder internal surface, which is bored in a cylinder body as one piece, and another portion between first and second piston guide portions of the cylinder internal surface.

### INCORPORATION BY REFERENCE

This application is based on and claims priority under 35 U.S.C. 119 with respect to Japanese Application No. 2003-310977 filed on Sep. 3, 2003, the entire content of which is incorporated herein by reference.

### BACKGROUND OF THE INVENTION

1. Field of the Invention

The present invention relates to a brake master cylinder for use in a brake system for a vehicle and a manufacturing method therefor.

2. Discussion of the Related Art

Heretofore, there has been known a brake master cylinder described in U.S. Pat. No. 6,381,959 B1 (equivalent of Japanese unexamined, published patent application No. 2001-138893. In the known brake master cylinder, a metal-made cylinder body is constituted by screwing a rear body into a rear end of an internal bore formed in a front body. A metal-made first piston is slidably inserted into a resin-made first piston guide which is fit in a rear end portion of an internal bore formed in the rear body, and a metal-made second piston is slidably inserted into a resin-made second piston guide which is fit in an intermediate portion of the internal bore formed in the front body. First and second cup seals are fitted respectively on the first and second pistons thereby to partition the internal bore into first and second fluid chambers for respectively supplying brake fluids to first and second brake systems. The first and second cup seals are kept in contact respectively with front surfaces of the first and second piston guides, and a fluid-tight seal element which partitions the front end of the first fluid chamber is kept in contact with a back surface of the second piston guide. Further, a resin-made, cylindrical sleeve which slidably fits the first and second pistons therein is fit in the internal bore between the first cup seal and the fluid-tight seal.

In the brake master cylinder in the foregoing prior art, the first and second pistons are free from metal-to-metal contact with the cylinder body and hence, free from being abrasively injured, so that the brake master cylinder is highly reliable in that the slide portions of the cup seals are not damaged. However, because of taking a cylindrical shape, the resin-made sleeve cannot be arranged between the first cup seal, which is kept in contact with the first piston guide fit in the rear body, and the fluid-tight seal element unless the cylinder body is divided into the front body and the rear body. This disadvantageously increases the number of the components therefor and makes the construction complicated.

### SUMMARY OF THE INVENTION

Accordingly, it is a primary object of the present invention to provide an improved brake master cylinder capable of having a sleeve inserted into a one-piece cylinder body so that the master cylinder can be simplified in construction and decreased in number of the components therefor.

Briefly, in a brake master cylinder according to the present invention, a cylinder body is provided with a cylinder formed therein, a first piston is inserted into a first piston guide portion provided at a rear end portion of the cylinder, and a second piston is inserted into a second piston guide portion provided at an intermediate portion of the cylinder. First and second cup seals respectively fitting on the first and second pistons are respectively provided at front end portions of the first and second piston guide portions thereby to partition the cylinder into first and second cylinder chambers which supply brake fluids respectively to first and second brake systems, and a fluid-tight seal element is provided behind the second piston guide portion for defining a front end of the first fluid chamber. The brake master cylinder is characterized by providing a sleeve recess having an outer diameter larger than outer diameters of the first and second pistons and formed at least one of a part between the first and second pistons of the cylinder internal surface and another part at the first piston guide portion of the cylinder internal surface, and a sleeve made of a softer material than the first and second pistons and fit in the sleeve recess wherein the sleeve is separated at at least one portion in the circumferential direction throughout the whole length thereof.

With this construction, when the first piston is pushed forward, the first and second fluid chambers partitioned respectively by the first and second cup seals supply brake fluids therefrom respectively to the first and second brake systems. Even if the first piston is slightly inclined upon receiving the pushing force at this time, it comes into contact with the sleeve which is softer than the first piston without contacting with the cylinder body. Since the first piston is not abrasively injured, it does not occur that the first cup seal is injured at the slide guide portion thereof. Further, the sleeve is separated at at least one portion in the circumferential direction throughout the whole length thereof, so that by being inserted from the opening end of the cylinder, the sleeve can be fit in the sleeve recess which is annually formed at at least one of the part between the first and second pistons of the cylinder internal surface and the another part at the first piston guide portion of the cylinder internal surface. Thus, it becomes realized to attach the sleeve into the cylinder body which is not divided into a front body and a rear body. Therefore, the brake master cylinder according to the present invention can be simplified in construction, reduced in number of the components therefor and enhanced in reliability.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a longitudinal sectional view of a brake master cylinder according to an embodiment of the present invention;

FIG. 2 is a perspective view of a second sleeve incorporated in the brake master cylinder;

FIG. 3 is a perspective view of a first sleeve incorporated in the brake master cylinder;

FIG. 4 is an explanatory view showing the state of the second sleeve in which the same is wound and fit in a jig to be overlapped partly; and

FIG. 5 is a perspective view showing a modified form of the first sleeve.

### DETAILED DESCRIPTION OF THE PREFERRED EMBODIMENT

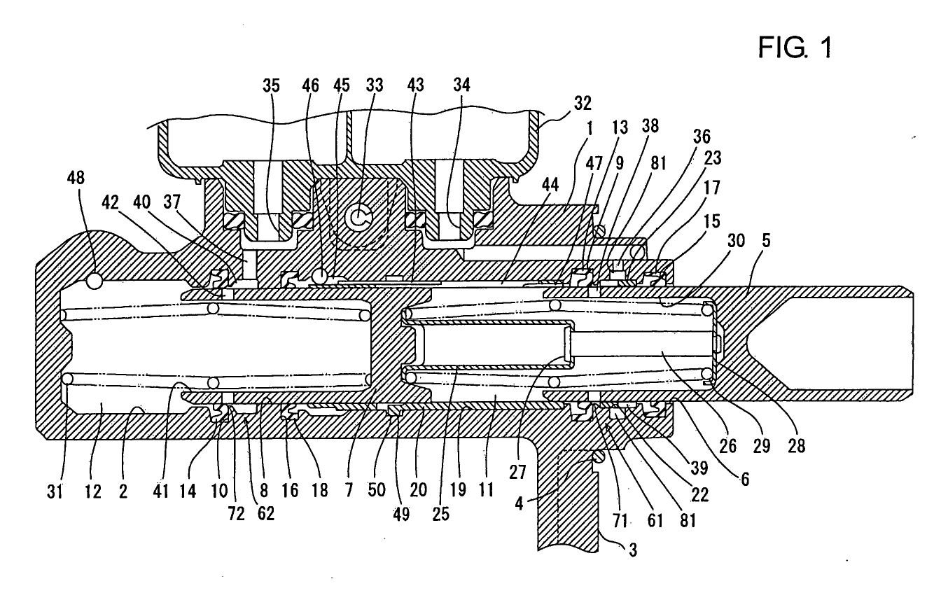

A master cylinder according to an embodiment of the present invention will be described hereinafter with reference to the accompanying drawings. Referring now to FIG. 1, a metal-made cylinder body 1 is shown formed with a cylinder 2 having a bottom wall at its front end and opening at its rear end. At the rear end portion of the cylinder body 1, there is formed a booster attaching surface 3, to which a booster of a vacuum booster device (not shown) is secured through an O-ring 4. At the rear end portion of the cylinder 2 and beside a first cup seal 13, there is formed a first piston guide portion 61, into which a metal-made first piston 5 is inserted with a play. At the intermediate portion of the cylinder 2 and beside a second cup seal 14, there is formed a second piston guide portion 62, into which a metal-made second piston 7 is inserted with a play. The front end portions of the first and second piston guide portions 61, 62 are formed with annular grooves 9, 10, in which the first and second cup seals 13, 14 are fit, respectively. These seals 13, 14 are respectively fit at inner lip portions thereof on the first and second pistons 5, 7 thereby to partition the cylinder 2 into first and second fluid chambers 11, 12 which are provided respectively for supplying pressurized brake fluids to first and second brake systems (not shown). The first and second cup seals 13, 14 are backed up at back surfaces thereof on rear walls of the annular grooves 9, 10 and make front portions of outer lip portions thereof face front walls of the annular grooves 9, 10 with slight clearances so that they are suppressed from moving axially, respectively. Radial clearances are provided respectively between first and second annular walls, constituting the rear walls of the annular grooves 9, 10, and the first and second pistons 5, 7. When the first and second pistons 5, 7 are returned rearward, the brake fluids are supplied from the back sides of the first and second cup seals 13, 14 to the front sides thereof through the radial clearances, respectively. The first and second piston guide portions 61, 62 are provided at rear end portions thereof with annular grooves 15, 16, in which fluid-tight seal elements 17, 18 are arranged to slidably fit on the first and second pistons 5, 7, respectively.

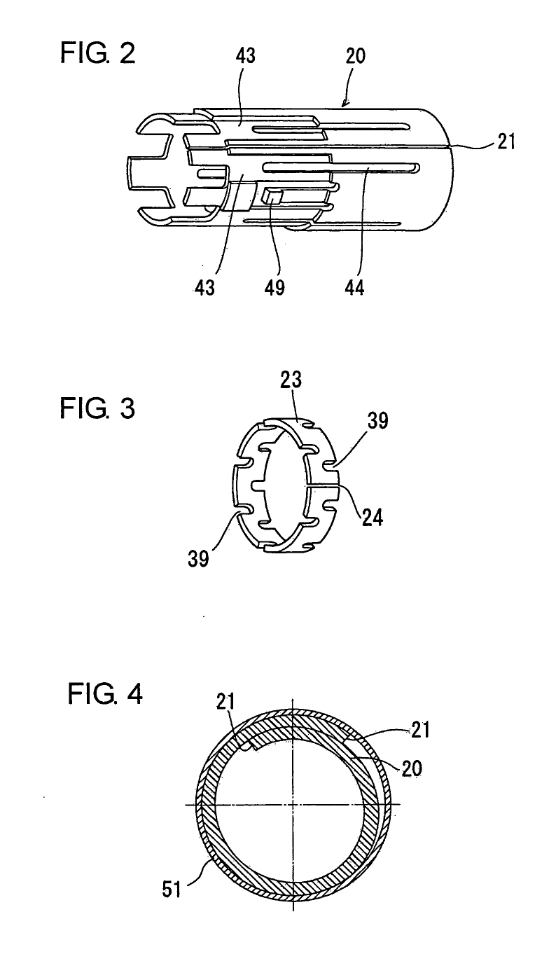

In the internal surface of the cylinder 2, a second sleeve recess 19 which is larger in outer diameter than the first and second pistons 5, 7 is formed between the first and second piston guide portions 61, 62 to extend axially therebetween. The second sleeve recess 19 has fitted therein a second sleeve 20 made of a material which is softer than the first and second pistons 5, 7 and which is elastically deformable, such as, e.g., a resin made from aromatic polyamide nylon or the like. As shown in FIG. 2, the second sleeve 20 is axially cut to be separated at at least one portion in the circumferential direction throughout the whole length thereof and is fit in the second sleeve recess 19 annually formed between the first and second piston guide portions 61, 62, by being inserted from the opening end of the cylinder 2 with the both separated ends 21, 21 thereof being windingly overlapped. A reference numeral 49 denotes a protrusion portion formed at a part of the external surface of the second sleeve 20. The second sleeve 20 is formed with axial cutaway apertures extending axially at both sides in the circumferential direction thereof and a circumferential cutaway aperture extending circumferentially at a front side thereof, and these cutaway apertures constitute a U-shape cutaway aperture so that the protrusion portion 49 can be elastically movable in the radial direction of the second sleeve 20. The second sleeve recess 19 is formed with a hollow portion 50 at a position thereon which corresponds to the protrusion portion 49 of the second sleeve 20 fit in the second sleeve recess 19. The second sleeve 20 is positioned with the protrusion portion 49 engaged with the hollow portion 50.

Referring back to FIG. 1, a first sleeve recess 22 larger in outer diameter than the first piston 5 is formed at an intermediate portion between the annular grooves 9,15 of the first piston guide portion 61. The first sleeve recess 22 has fit therein a first sleeve 23 made of a material which is softer than the first piston 5 and which is elastically deformable, such as, e.g., a resin made from aromatic polyamide nylon or the like. As shown in FIG. 3, the first sleeve 23 is axially cut to be separated at at least one portion in the circumferential direction throughout the whole length thereof and is fit in the first annular sleeve recess 22 by being inserted from the opening end of the cylinder 2 with both separated ends 24 thereof being windingly overlapped. Plural slits 39 circumferentially arranged in a zigzag fashion are formed at both axial ends of the first sleeve 23 each to extend from each axial end to the axial mid portion of the first sleeve 23. The plural slits 39 provide passages for the brake fluid and at the same time, make it easy for the first sleeve 23 to be deformed elastically. The first piston 5 is inserted to be slidable in the rear portion of the second sleeve 20 as well as in the first sleeve 23, and the rear end portion of the first piston 5 enters a constant-pressure chamber of the booster (not shown) thereby to be pushed by an output shaft (not shown) of the booster. The second piston 7 is inserted to have a rear end portion thereof slidable in the front portion of the second sleeve 20 and generates a fluid pressure in the second fluid chamber 12 when pushed upon receiving a fluid pressure generated in the first fluid chamber 11. The second piston 7 is also slidably guided on a piston guide 8 formed on the cylinder internal surface.

A bell-like spring seat 25 is in abutting engagement at its front end with the rear end surface of the second piston 7, and a rod 26 pierces through a hole formed at the rear end of the spring seat 25, with a head portion 27 thereof being prevented from coming out from the hole. A spring shoe 28 is secured to a rear end of the rod 26, and a first compression spring 29 preliminarily compressed to generate a first set spring force is interposed between the spring seat 25 and the spring shoe 28. The spring shoe 28 rests at its rear end surface on a bottom surface of a first axial hole 30, which is formed in the first piston 5 to extend from a front end surface of the same in a rearward direction. A second axial hole 41 is formed in the second piston 7 to extend from a front end surface of the same in the rearward direction. A second compression spring 31 is interposed between a bottom surface of the second axial hole 41 and the bottom surface of the cylinder 2 and urges the second piston 7 rearward by a second set spring force weaker than the first set spring force thereby to make the second piston 7 rest on the spring seat 25.

A reservoir 32 is mounted on the top of the cylinder body 1 and is secured thereon by being connected by means of a pin 33. First and second outlet ports 34, 35 holed on a lower surface of the reservoir 32 are in communication respectively with first and second replenishing ports 36, 37 which are formed in the top portion of the cylinder body 1 respectively for replenishing brake fluids to the first and second fluid chambers 11, 12. The first replenishing port 36 opens to the first sleeve recess 22 by way of an annular communication passage 81 and, when the first piston 5 is positioned at an inoperative position, is brought into communication with first replenishing holes 38, which are holed in the first piston 5 radially thereof to open to the first axial hole 30, by way of the slits 39 of the first sleeve 23 fit in the first sleeve recess 22. The second replenishing port 37 is in communication with an annular hole 40 holed at an intermediate portion of the second piston guide portion 62 in adjoining relation to the piston guide 8 and, when the second piston 7 is positioned at an inoperative position, is brought into communication with second replenishing holes 42 which are holed in the second piston 7 radially of the same to open to the second axial hole 41.

As shown in FIG. 2, the second sleeve 20 has formed thereon plural passages for permitting the brake fluid and the air infused in the same to pass therethrough. Plural hollow portions 43 are formed on the external surface of the second sleeve 20 to extend from a front end to an intermediate portion of the second sleeve 20. In each of the hollow portions 43, an elongate aperture 44 is cut away therefrom to extend axially, so that each hollow portion 43 is in communication with the first fluid chamber 11 inside the second sleeve 20. The cylinder 2 has an annular port recess 45 slightly behind the fluid-tight seal element 18, and each of the hollow portions 43 extends into the annular port recess 45. A first port 46 holed in the cylinder body 1 in communication with the first brake system is opened in the annular port recess 45. Plural communication slits 47 are formed on the rear end internal surface of the second sleeve 20 to extend axially of the same. A second port 48 holed in communication with the second brake system is opened at the bottom portion of the cylinder body 1.

In fitting the second sleeve 20 in the second sleeve recess 19, as shown in FIG. 4, the second sleeve 20 is first wound along the internal surface of a cylindrical thin jig 51, whose outer diameter is slightly smaller than the inner diameter of the cylinder 2, so that the both separated ends 21, 21 axially cut off of the second sleeve 20 are overlapped on each other. In this state, the jig 51 is inserted from the opening end of the cylinder 2 until the protrusion portion 49 is brought into alignment with the hollow portion 50 in the circumferential direction and until the second sleeve 20 is brought into alignment with the second sleeve recess 19 in the axial direction. Then, the jig 51 is drawn out from the cylinder 2 with the second sleeve 20 being kept in axial alignment with the second sleeve recess 19. When released from the jig 51, the second sleeve 20 is elastically deformed to expand, whereby it is fit in the second sleeve recess 19. If the protrusion portion 49 is not dropped into the hollow portion 50 at this time, the second sleeve 20 is rotated and/or axially moved until the former is engaged with the latter.

The operation of the embodiment as constructed above will be described hereinafter. When a brake pedal (not shown) is stepped on, an output rod of the vacuum booster device (both not shown) boosts the stepping force on the pedal to push the first piston 5 forward. With the forward movement of the first piston 5, the first replenishing holes 38 are caused by the first cup seal 13 to be brought out of communication with the first replenishing port 36. After the fist replenishing holes 38 are blocked, the further movement of the first piston 5 causes the brake fluid in the first fluid chamber 11 to increase in pressure, and the brake fluid is supplied to the first brake system (not shown) through the elongate apertures 44, the hollow portions 43, the annular port recess 45 and the first port 46. The pressure increase of the fluid in the first fluid chamber 11 causes the second piston 7 to be pushed forward, and with the forward movement of the second piston 7, the second replenishing holes 42 are caused by the second cup seal 14 to be brought out of communication with the second replenishing port 37. Thereafter, the further movement of the second piston 7 causes the fluid in the second fluid chamber 12 to increase in pressure, whereby the brake fluid is supplied from the second port 48 to the second brake system (not shown).

Even when the pushing force exerted by the output rod of the vacuum booster device causes the first piston 5 to incline slightly, the metal-made first piston 5 is slidably guided on the soft second sleeve 20 and the soft first sleeve 23, so that it does not come into contact with the metal-made cylinder body 1. Therefore, since the first piston 5 is not abrasively injured, it does not occur that the first cup seal 13 is injured at the slide guide portion thereof. Since the second piston 7 is pushed upon receiving the pressure in the first fluid chamber 12, it hardly occurs that the second piston 7 is inclined upon receiving the pushing force. For this reason, no sleeve is fit in the annular recess 40 formed ahead of the piston guide 8. However, a sleeve like the first sleeve 23 which is fit in the first sleeve recess 22 may be fit in the annular recess 40.

When the brake pedal is released from being stepped on, the first piston 5 is retracted by the resilient force of the first compression spring 29 until the head portion 27 of the rod 26 is brought into contact with the spring seat 25. Thereafter, the first piston 5, together with the second piston 7, is retracted by the resilient force of the second compression spring 31.

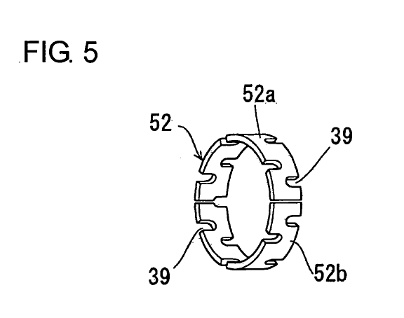

Although in the foregoing embodiment, each of the second sleeve 20 and the first sleeve 23 is cut off along the axis thereof at at least one portion in the circumferential direction, each of the first sleeve 23 and the second sleeve 20 may be divided into several pieces by being axially cut off at several portions in the circumferential direction as typically exemplified by a modified first sleeve 52 which is divided into two semicircular sector portions 52a, 52b shown in FIG. 5. In this modified case, the first sleeve 23 and the second sleeve 20 need not to be made of an elastically deformable material.

Various features and many of the attendant advantages in the foregoing embodiment will be summarized as follows:

In the brake master cylinder in the foregoing embodiment shown in FIGS. 1 to 3, when the pistons 5, 7 are pushed forward, the first and second fluid chambers 11, 12 partitioned respectively by the first and second cup seals 13, 14 supply brake fluids therefrom respectively to the first and second brake systems. Even if the first piston 5 is slightly inclined upon receiving the pushing force at this time, it comes into contact with the sleeve 23 which is softer than the first piston 5, without contacting with the cylinder body 1. Since the first piston 5 is not abrasively damaged, it does not occur that the first cup seal 13 is injured at the slide guide portion thereof. Further, the sleeve 20 or 23 is separated at at least one portion in the circumferential direction throughout the whole length thereof, so that by being inserted from the opening end of the cylinder 2, the sleeve 20 or 23 can be fit in the sleeve recess 19 or 22 which is annually formed at at least one of a part between the first and second pistons 5, 7 of the cylinder 2 internal surface and another part at the first piston guide portion 61 of the cylinder 2 internal surface. Thus, it becomes realized to attach the sleeve 20 or 23 into the cylinder body 1 which is not divided into a front body and a rear body. Therefore, the brake master cylinder according to the present invention can be simplified in construction, reduced in number of the components therefor and enhanced in reliability.

Also in the brake master cylinder in the foregoing embodiment typically shown in FIG. 1, the first and second cup seals 13, 14 are received respectively in the annular grooves 9, 10 which are formed respectively at front portions of the first and second piston guide portions 61, 62. Thus, there is not required any means like plates or the like for backing up the first and second cup seals 13, 14, so that the brake master cylinder can be simplified in construction and reduced in number of the components therefor.

Also in the brake master cylinder in the foregoing embodiment typically shown in FIGS. 1 and 2, the protrusion portion 49 is provided on the external surface of the second sleeve 20 to be elastically movable in the radial direction of the second sleeve 20, and the second sleeve 20 is positioned with the protrusion portion 49 engaged with the hollow portion 50 provided in the second sleeve recess 19. Thus, with the simplified construction, it becomes possible to prevent the second sleeve 20 from being moved as the first and second pistons 5, 7 are moved axially.

Also in the brake master cylinder in the foregoing embodiment typically shown in FIG. 1, since the sleeves 20, 23 are made of a resin, it becomes possible to form the sleeves 20, 23 which are softer than the pistons 7, 5, into desired shapes at a lower cost.

Further, in the manufacturing method in the foregoing embodiment typically shown in FIGS. 1 and 5, the sleeves 23, 20 are made of an elastically deformable material which is softer than the first and second pistons 5, 7 and are each separated at one portion in the circumferential direction throughout the whole length thereof. Each sleeve 23 or 20 is wound along the internal surface of the cylindrical thin jig 51 whose outer diameter is slightly smaller that the inner diameter of the cylinder 2, with separated ends 21, 21 in the circumferential direction of the sleeve 23 or 20 being overlapped on each other. Then, the jig 51 is inserted into the cylinder 2 until the sleeve 23 or 20 is brought into alignment with the sleeve recess 23 or 20 in the axial direction thereof and then, is removed from the cylinder 2 with the sleeve 22 or 19 kept in axial alignment with the sleeve recess 22 or 19. Thus, it becomes realized to easily attach the sleeves 23, 20 in the annular sleeve recesses 22, 19 of the cylinder body 1 which is not divided into a front body and a rear body, so that the brake master cylinder which is simplified in construction, reduced in number of the components therefor and enhanced in reliability can be provided at a lower cost.

Obviously, numerous modifications and variations of the present invention are possible in light of the above teachings. It is therefore to be understood that within the scope of the appended claims, the present invention may be practiced otherwise than as specifically described herein.

1. In a brake master cylinder having a cylinder body with a cylinder formed therein; a first piston inserted into a first piston guide portion provided at a rear end portion of the cylinder; a second piston inserted into a second piston guide portion provided at an intermediate portion of the cylinder; first and second cup seals respectively provided at front end portions of the first and second piston guide portions for fitting respectively on the first and second pistons thereby to partition the cylinder into first and second cylinder chambers which respectively supply brake fluids to first and second brake systems; and a fluid-tight seal element provided behind the second piston guide portion for defining a front end of the first fluid chamber;
the improvement comprising:
a sleeve recess having an outer diameter larger than outer diameters of the first and second pistons and formed at at least one of a part between the first and second pistons of the cylinder internal surface and another part at the first piston guide portion of the cylinder internal surface; and
a sleeve made of a softer material than the first and second pistons and fit in the sleeve recess, the sleeve being separated at at least one portion in the circumferential direction throughout the whole length thereof.

2. The brake master cylinder as set forth in claim 1, wherein the first and second cup seals are received respectively in annular grooves which are formed respectively at front portions of the first and second piston guide portions.

3. The brake master cylinder as set forth in claim 1, wherein a protrusion portion is provided on an external surface of the sleeve to be elastically movable in a radial direction of the sleeve, and wherein the sleeve is positioned with the protrusion portion engaged with a hollow portion provided in the sleeve recess.

4. The brake master cylinder as set forth in claim 4, wherein the sleeve is made of a resin.

5. A method of manufacturing the brake master cylinder as set forth in claim 1, comprising the steps of:
making the sleeve of an elastically deformable material which is softer than the first and second pistons;
separating the sleeve at one portion in the circumferential direction throughout the whole length thereof;
winding the sleeve along an internal surface of a cylindrical thin jig whose outer diameter is slightly smaller that the inner diameter of the cylinder, with separated ends in the circumferential direction of the sleeve being overlapped on each other;
inserting the jig into the cylinder until the sleeve is brought into alignment with the sleeve recess in the axial direction thereof; and
removing the jig from the cylinder with the sleeve kept in axial alignment with the sleeve recess.
